(19) United States
(12) Patent Application Publication
(10) Pub. No.: US 2009/0128098 A1
(43) Pub. Date: May 21, 2009

(54) PULSE GENERATING CIRCUIT, CONTROL METHOD FOR PULSE GENERATING CIRCUIT, TRANSMITTER, AND ELECTRONIC DEVICE

(75) Inventor: Takeshi Nakajima, Matsumoto-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/275,193

(22) Filed: Nov. 20, 2008

(30) Foreign Application Priority Data
Nov. 21, 2007 (JP) 2007-301312
Aug. 28, 2008 (JP) 2008-219264

(51) Int. Cl. H02J 7/04; G05F 1/10

(52) U.S. Cl. 320/139; 327/536

(57) ABSTRACT

A pulse generating circuit includes: a boosting circuit which boosts power source voltage supplied from an external primary battery and produces boosted voltage higher than the power source voltage; a secondary battery to be charged with the boosted voltage; a pulse circuit which generates a pulse; a switch element connected between the secondary battery and the pulse circuit; and a control circuit which enables the boosting circuit and switches off the switch element during a charge period for charging the secondary battery with the boosted voltage, and disenables the boosting circuit and switches on the switch element during a discharge period for discharging the boosted voltage contained in the secondary battery.

### BACKGROUND

1. Technical Field

The present invention relates to a pulse generating circuit, a control method for a pulse generating circuit, a transmitter, and an electronic device, capable of generating pulse train in correspondence with time of change point or symbol point of data by using pulse train constituted by a single pulse or a plurality of pulses.

2. Related Art

According to recent wireless communication system, continuous transmission or reception of carrier waves (carrier) is not performed, but the method of so-called “intermittent transmission” or “intermittent reception” which turns on power source only during necessary periods for transmission or reception operation is employed for the purpose of reduction of power consumption.

For example, JP-A-2006-50354 discloses the method of intermittent transmission which achieves low-voltage operation and low power consumption. FIG. 3A is a circuit diagram showing a pulse generating device according to JP-A-2006-50354, and FIG. 3B is a timing chart showing the pulse generating device according to JP-A-2006-50354.

When pulse PS is intermittently generated for communication in related art, a large volume of current (high power) is required at the instant of generation of the pulse PS. Thus, a primary battery PU having large output capacity sufficient for receiving excessive load is needed. Also, for reducing fluctuations in power source voltage caused by excessive load, a large-volume capacitor or an additional secondary battery C14 is necessary. Moreover, when other application operates simultaneously with the generation of the pulse PS, power is further required. In this case, the primary battery PU having larger output capacity and the secondary battery C14 having larger volume are needed.

### SUMMARY

It is an advantage of some aspects of the invention to solve at least a part of the problems described above by providing the following examples and applications.

A pulse generating circuit according to a first aspect of the invention includes: a boosting circuit which boosts power source voltage supplied from an external primary battery and produces boosted voltage higher than the power source voltage; a secondary battery to be charged with the boosted voltage; a pulse circuit which generates a pulse; a switch element connected between the secondary battery and the pulse circuit; and a control circuit which enables the boosting circuit and switches off the switch element during a charge period for charging the secondary battery with the boosted voltage, and disenables the boosting circuit and switches on the switch element during a discharge period for discharging the boosted voltage contained in the secondary battery.

According to this structure, the pulse is generated by boosting the voltage using a small volume of current during the charge period for charging the secondary battery with the boosted voltage, and then discharging the charges of the boosted voltage contained in the secondary battery at a time. Thus, the primary battery having small capacity and low load can be used, and the life of the primary battery can be extended. In this case, high charges can be discharged by accumulating the boosted voltage higher than the power source voltage even when the capacity of the secondary battery is small. Thus, the secondary battery having small size and small capacity can be used, and reduction in part cost and mounting area can be achieved Moreover, the instantaneous peak power can be lowered by generating the pulse in the interval between operations of other applications. Thus, the size and capacity of the primary battery can be reduced.

It is preferable that the boosting circuit is a charge pump circuit.

According to this structure, the pulse is generated by boosting the voltage using a small volume of current during the charge period for charging the secondary battery with the boosted voltage, and then discharging the charges of the boosted voltage contained in the secondary battery at a time. Thus, the primary battery having small capacity and low load can be used, and the life of the primary battery can be extended. In this case, high charges can be discharged by accumulating the boosted voltage higher than the power source voltage even when the capacity of the secondary battery is small. Thus, the secondary battery having small size and small capacity can be used, and reduction in part cost and mounting area can be achieved Moreover, the instantaneous peak power can be lowered by generating the pulse in the interval between operations of other applications. Thus, the size and capacity of the primary battery can be reduced.

A transmitter according to a second aspect of the invention includes: the pulse generating circuit described above; and an antenna which radiates the pulse generated by the pulse circuit.

According to the transmitter having this structure, the pulse is generated by boosting the voltage using a small volume of current during the charge period for charging the secondary battery with the boosted voltage, and then discharging the charges of the boosted voltage contained in the secondary battery at a time. Thus, the primary battery having small capacity and low load can be used, and the life of the primary battery can be extended. In this case, high charges can be discharged by accumulating the boosted voltage higher than the power source voltage even when the capacity of the secondary battery is small. Thus, the secondary battery having small size and small capacity can be used, and reduction in part cost and mounting area can be achieved. Moreover, the instantaneous peak power can be lowered by generating the pulse in the interval between operations of other applications. Thus, the size and capacity of the primary battery can be reduced.

An electronic device according to a third aspect of the invention includes the pulse generating circuit described above.

According to the electronic device having this structure, the pulse is generated by boosting the voltage using a small volume of current during the charge period for charging the secondary battery with the boosted voltage, and then discharging the charges of the boosted voltage contained in the secondary battery at a time. Thus, the primary battery having small capacity and low load can be used, and the life of the primary battery can be extended. In this case, high charges can be discharged by accumulating the boosted voltage higher than the power source voltage even when the capacity of the secondary battery is small. Thus, the secondary battery having small size and small capacity can be used, and reduction in part cost and mounting area can be achieved. Moreover, the instantaneous peak power can be lowered by generating the pulse in the interval between operations of other applications. Thus, the size and capacity of the primary battery can be reduced.

A control method for controlling a pulse generating circuit which contains a boosting circuit which boosts power source voltage supplied from an external primary battery and produces boosted voltage higher than the power source voltage, a secondary battery to be charged with the boosted voltage, a pulse circuit which generates a pulse, and a switch element connected between the secondary battery and the pulse circuit according to a fourth aspect of the invention includes: a boosting step for enabling the boosting circuit and switching off the switch element during a charge period, and charging the secondary battery with the boosted voltage; and a pulse generating step for disenabling of the boosted circuit and switching on the switch element during a discharge period, and discharging the boosted voltage contained in the secondary battery to supply the boosted voltage to the pulse circuit and generate the pulse.

According to this method, the pulse is generated by boosting the voltage using a small volume of current during the charge period for charging the secondary battery with the boosted voltage, and then discharging the charges of the boosted voltage contained in the secondary battery at a time. Thus, the primary battery having small capacity and low load can be used, and the life of the primary battery can be extended. In this case, high charges can be discharged by accumulating the boosted voltage higher than the power source voltage even when the capacity of the secondary battery is small. Thus, the secondary battery having small size and small capacity can be used, and reduction in part cost and mounting area can be achieved Moreover, the instantaneous peak power can be lowered by generating the pulse in the interval between operations of other applications. Thus, the size and capacity of the primary battery can be reduced.

### BRIEF DESCRIPTION OF THE DRAWINGS

The invention will be described with reference to the accompanying drawings, wherein like numbers reference like elements.

FIG. 1 is a circuit diagram showing a structure of a pulse generating circuit according to a first embodiment.

FIG. 2 is a timing chart showing operation of the pulse generating circuit.

FIG. 3A is a circuit diagram showing a structure of a pulse generating circuit in related art.

FIG. 3B is a timing chart of the pulse generating circuit shown in FIG. 3A.

FIG. 4 illustrates a structure example of an electronic device according to a modified example 1.

FIG. 5 is a circuit diagram showing a structure of a pulse generating circuit according to a modified example 2.

FIG. 6 is a circuit diagram showing a structure of a pulse generating circuit according to a modified example 3.

FIG. 7 is a circuit diagram showing a structure of a pulse generating circuit according to a modified example 4.

FIG. 8 is a timing chart showing operation of the pulse generating circuit according to the modified example 4.

FIG. 9 schematically illustrates an application example of the pulse generating circuit according to the modified example 4.

### DESCRIPTION OF EXEMPLARY EMBODIMENTS

A pulse generating circuit as embodiments of the invention is hereinafter described with reference to the drawings.

### First Embodiment

### Structure of Pulse Generating Circuit

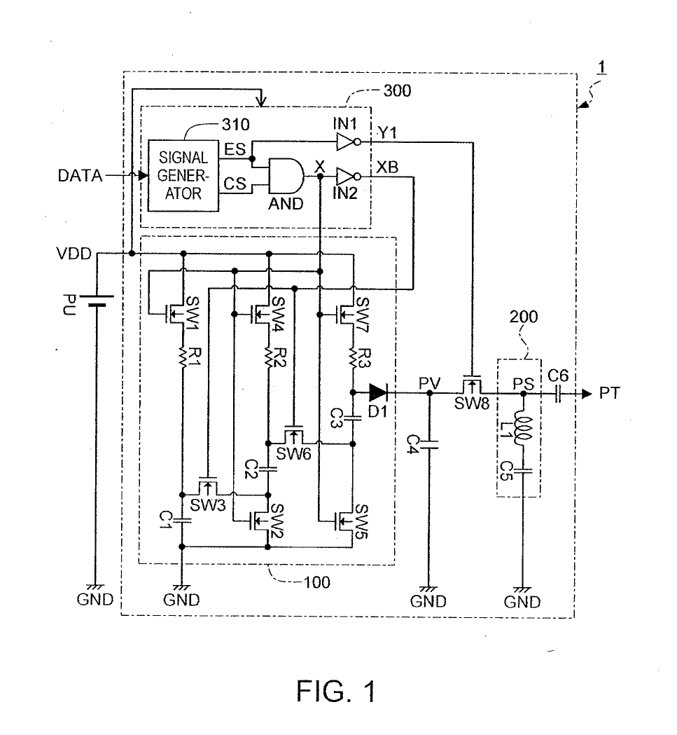

Initially, a structure of a pulse generating circuit according to a first embodiment is discussed with reference to FIG. 1. FIG. 1 is a circuit diagram showing the structure of the pulse generating circuit in the first embodiment.

As illustrated in FIG. 1, a pulse generating circuit 1 includes a boosting circuit 100 which boosts power source voltage VDD supplied from an external primary voltage PU and generates boosted voltage PV higher than the power source voltage VDD, a secondary battery C4 which charges the boosted voltage PV (or large-volume capacitor or the like), a pulse circuit 200 which generates pulse PS, a switch element SW8 connected between the secondary battery C4 and the pulse circuit 200, a control circuit 300 which enables the boosting circuit 100 and switches off the switch element SW8 during a charge period for charging the secondary battery C4 with the boosted voltage PV, and disenables the boosting circuit 100 and switches on the switch element SW8 during a discharge period for discharging the boosted voltage PV contained in the secondary battery C4, and a capacitor C6 connected between the pulse circuit 200 and a pulse output pin PT.

According to this embodiment, a charge pump circuit capable of boosting the power source voltage VDD up to three times higher is used as a boosting circuit 100. However, to what time the power source voltage needs to be boosted may be determined according to applications.

The boosting circuit 100 has a switch element SW1, a resistor R1, and a capacitor C1 connected in series between the power source voltage VDD and a ground line GND, a switch element SW4, a resistor R2, a capacitor C2, and a switch element SW2 connected in series between the power source voltage VDD and the ground line GND, a switch SW7, a resistor R3, a capacitor C3, and a switch SW5 connected in series between the power source voltage VDD and the ground line GND, a switch element SW3 connected between the connection point of the resistor R1 and the capacitor C1 and the connection point of the capacitor C2 and the switch element SW2, a switch element SW6 connected between the connection point of the resistor R2 and the capacitor C2 and the connection point of the capacitor C3 and the switch element SW5, and a diode D1 connected with the connection point of the resistor R3 and the capacitor C3 to output the boosted voltage PV.

The pulse circuit 200 is an LC in-series resonating circuit constituted by an inductor L1 and a capacitor C5 connected in series between the ground line GND and the connection point of the switch element SW8 and the capacitor C6.

A control circuit 300 includes a signal generator 310 which outputs a charge signal CS and an enable signal ES based on a data signal DATA inputted from the outside, an AND circuit AND which inputs a charge signal CS and the enable signal ES and outputs a switching signal X, an inverter IN2 which inverts the switching signal X and outputs an inverted switching signal XB, and an inverter IN1 which inverts the enable signal ES and outputs a discharge signal Y1. The switching signal X is inputted to gate pins of the switch elements SW1, SW2, SW4, SW5, and SW7 of the boosting circuit 10. The inverted switching signal XB is inputted to the gate pins of the switch elements SW6 and the switch element SW3 of the boosting circuit 100. The discharge signal Y1 is inputted to the gate pin of the switch element SW8.

### Operation of Pulse Generating Circuit

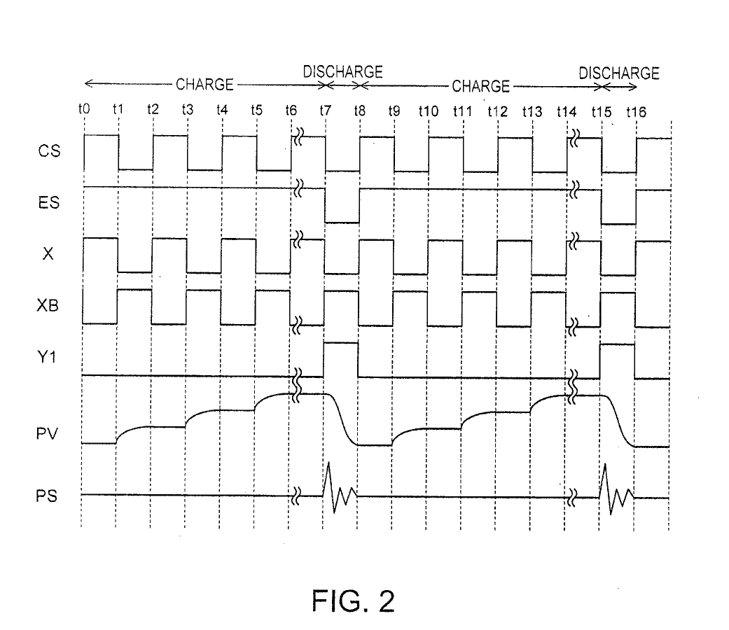

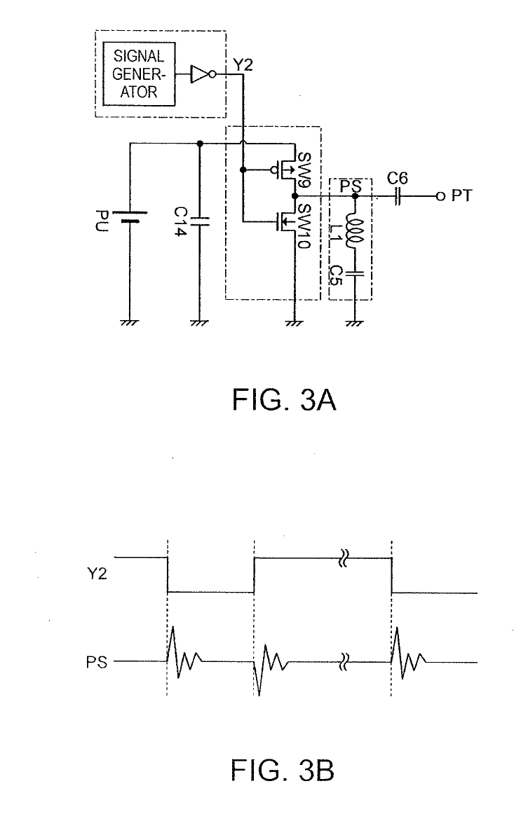

The operation of the pulse generating circuit is now explained with reference to FIG. 2. FIG. 2 is a timing chart showing the operation of the pulse generating circuit. Each of the switch elements SW1 through SW8 is constituted by Nch-type MOSFET of the like which provides continuation condition when the voltage of the gate pin is H level and non-continuation condition when that voltage is L level.

As illustrated in FIG. 2, the signal generator 310 of the control circuit 300 outputs a charge signal CS and the enable signal ES. The charge signal CS changes to H level at the time t0, L level at t1, and H level at t2, and repeats changing in this manner. The enable signal ES maintains H level during the period from t0 to t7, changes to L level at t7, changes to H level at t8, maintains H level during the period from t8 to t15, changes to L level at t15, changes to H level at t16, and repeats changing in this manner.

The switching signal X operates in the manner similar to that of the charge signal CS during the periods from t0 to t7 and from t8 to t15 in which the enable signal ES maintains H level (similarly operates in the following periods), and changes to L level during the periods from t7 to t8 and from t15 to t16 in which the enable signal ES maintains L level (similarly operates in the following periods). The inverted switching signal XB performs inverted operation of the switching signal X. The discharge signal Y1 performs inverted operation of the enable signal ES. More specifically, the discharge signal Y1 maintains L level during the periods from t0 to t7, and H level during the periods from t7 to t8, and repeats operation in the same manner.

The boosting circuit 100 operates based on the switching signal X and the inverted switching signal XB discussed above. Initially, during the period from t0 to t1, the switch elements SW1, SW2, SW4, SW5, and SW7 of the boosting circuit 100 are in continuation condition, and the switch elements SW3 and SW6 are in non-continuation condition, since the switching signal X and the inverted switching signal XB are H level and L level, respectively. During this period, the capacitors C1, C2, and C3 are charged.

During the period from t1 to t2, the switching signal X and the inverted switching signal XB are L level and H level, respectively. Thus, the switch elements SW1, SW2, SW4, SE5, and SE7 of the boosting circuit 100 are in non-continuation condition, and the switch elements SW3 and SW6 of the boosting circuit 100 are in continuation condition. In this period, the capacitors C1, C2, and C3 are connected in series between the input pin of the diode D1 and the ground line GND. As a result, the secondary battery C4 is charged with the total voltage in the capacitors C1, C2, and C3 accumulated from the output pin of the diode D1 to obtain the boosted voltage PV shown in FIG. 2.

When the operation in the periods from t0 to t2 discussed above is repeated during the periods from t2 to t4, the secondary battery C4 is charged with the total voltage in the capacitors C1, C2, and C3 accumulated from the output pin of the diode D1 to obtain the boosted voltage PV shown in FIG. 2.

Operation similar to the above operation is repeated until the period t7. The period from t0 to t7 (boosting step) is a charge period for charging the secondary battery C4 with the boosted voltage PV. The same applies to the periods from t8 to t15.

During the discharge period from t7 to t8, the discharge signal Y1 is H level. Thus, the switch element SW8 is in continuation condition, and the secondary battery C4 and the pulse circuit 200 are in continuation condition. During this period, the boosted voltage PV contained in the secondary battery C4 is discharged to the pulse circuit 200. As a result, the pulse PS is generated (pulse generating step). When the boosted voltage PV in the secondary battery C4 is discharged to 0V by the period t8, the pulse PS is stopped. Since the switching signal X and the inverted switching signal XB are L level and H level, respectively, the voltage accumulated in the capacitors C1, C2, and C3 are also discharged.

Thereafter, the operation during the periods from t0 to t8 is repeated also during the periods from t8 to t16 to intermittently generate the pulse PS.

According to this embodiment, the following advantages are offered.

In this embodiment, the pulse is generated by boosting the voltage using a small volume of current during the charge period for charging the secondary battery C4 with the boosted voltage PV, and then discharging the charges of the boosted voltage PV contained in the secondary battery C4 at a time. Thus, the primary battery having small capacity and low load can be used, and the life of the primary battery can be extended. In this case, high charges can be discharged by accumulating the boosted voltage PV higher than the power source voltage even when the capacity of the secondary battery C4 is small. Thus, the secondary battery having small size and small capacity can be used, and reduction in part cost and mounting area can be achieved. Moreover, the instantaneous peak power can be lowered by generating the pulse in the interval between operations of other applications. Thus, the size and capacity of the primary battery can be reduced.

While the example of the pulse generating circuit has been discussed, it is intended that the invention may be practiced otherwise without departing from the scope of the invention. For example, the following modifications may be made.

### MODIFIED EXAMPLE 1

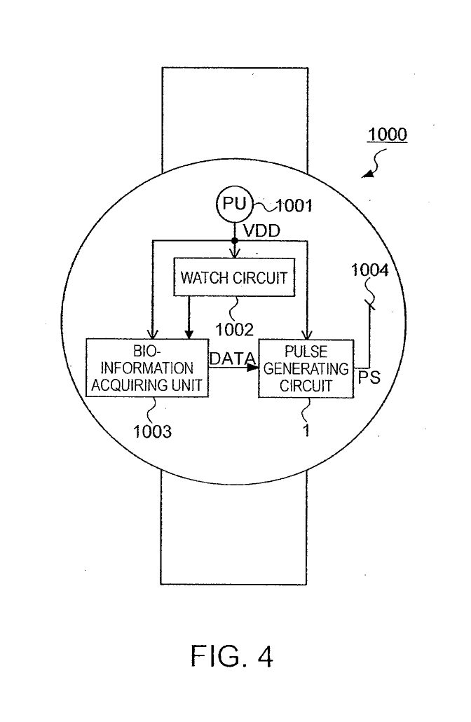

A pulse generating circuit according to a modified example 1 is now described. FIG. 4 illustrates an electronic watch 1000 having a function of transmitting bio-information by using a coin battery 1001 as the primary battery PU having small capacity and low load as an example of electronic device containing the pulse generating circuit 1. The electronic watch 1000 includes a watch circuit 1002 and a bio-information acquiring unit 1003, and is constructed such that a data signal DATA given from the bio-information acquiring unit 1003 can be transmitted to the outside from an antenna 1004 via the pulse generating circuit 1. Micro environmental sensor and bio sensor also use micro battery having small capacity and low load, and thus the pulse generating circuit 1 is useful for transmitting sensor information to the outside. Moreover, portable devices such as cellular phone, game machine, and audio player need to reduce part mounting space and power consumption. Accordingly, using the pulse generating circuit 1 is extremely advantageous for the purpose of communication with the outside.

### MODIFIED EXAMPLE 2

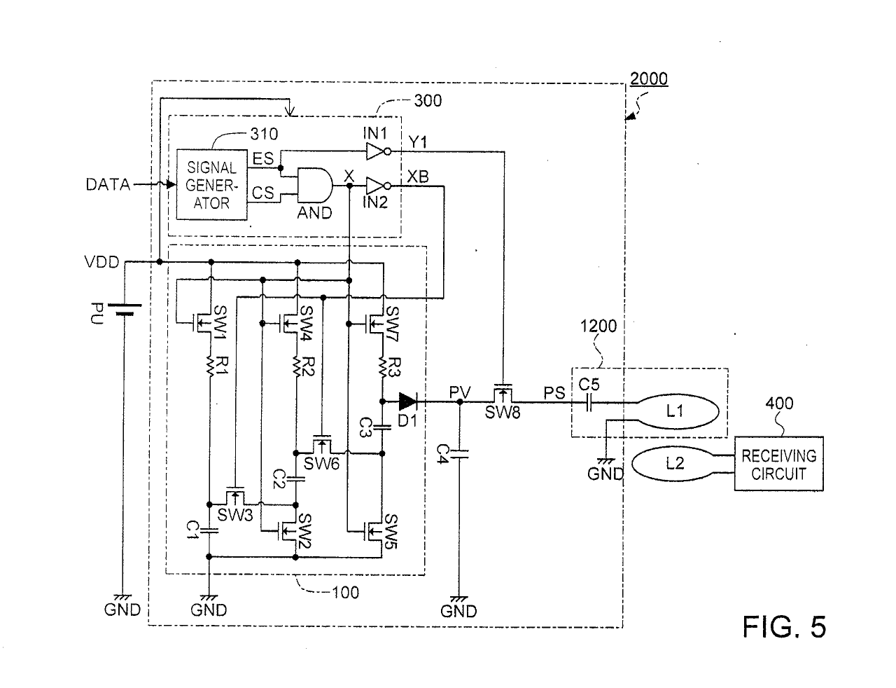

A pulse generating circuit according to a modified example 2 is now described. FIG. 5 is a circuit diagram showing the structure of the pulse generating circuit in the modified example 2. A pulse generating circuit 2000 shown in FIG. 5 is an example in which the inductor L1 of the pulse circuit 200 is used as a loop antenna functioning as antenna. The pulse circuit 1200 has the capacitor C5 and the inductor L1 connected in series between the switch element SW8 and the ground line GND. The pulse PS transmitted from the inductor L1 is received by an inductor L2 provided on a receiving circuit 400.

### MODIFIED EXAMPLE 3

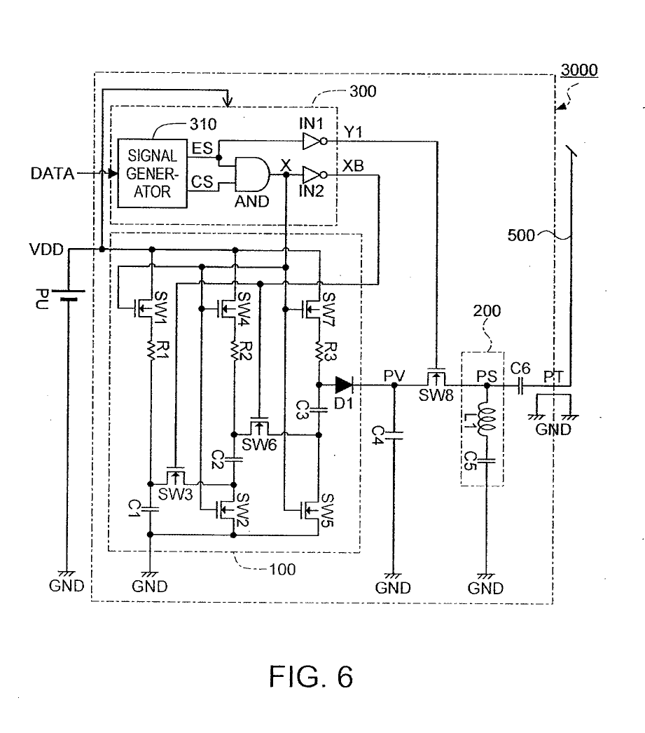

A pulse generating circuit according to a modified example 3 is now described. FIG. 6 is a circuit diagram showing the structure of the pulse generating circuit in the modified example 3. The pulse generating circuit 3000 shown in FIG. 6 is a transmitter having a mono-pole antenna 500 as an antenna connected to a pulse output pin PT.

### MODIFIED EXAMPLE 4

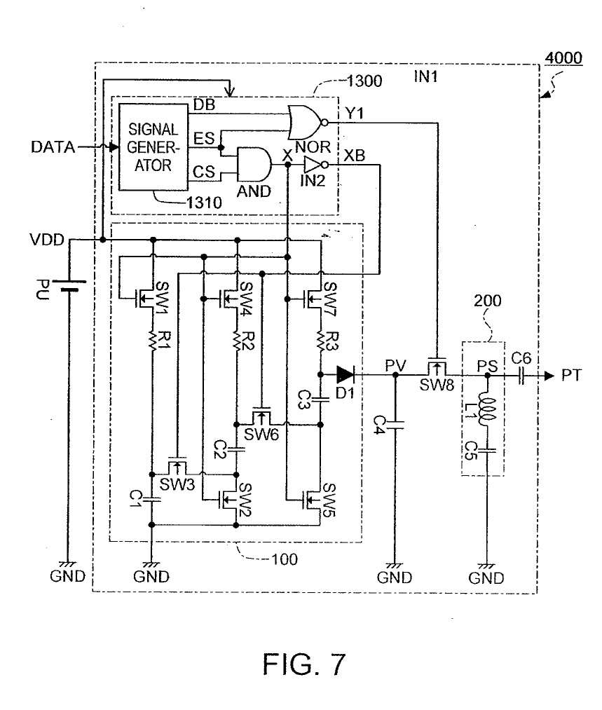

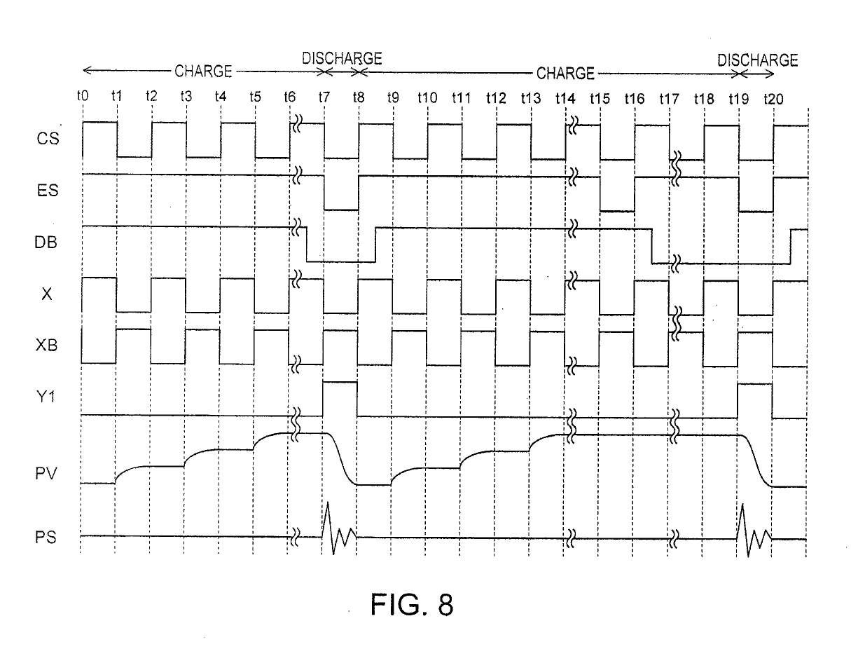

A pulse generating circuit according to a modified example 4 is now described. FIG. 7 is a circuit diagram showing the structure of the pulse generating circuit in the modified example 4. A pulse generating circuit 4000 shown in FIG. 7 uses a control circuit 1300 in place of the control circuit 300 shown in FIG. 1. The control circuit 1300 has a NOR circuit NOR instead of the inverter IN1 of the control circuit 300 shown in FIG. 1, and controls whether the discharge signal Y1 is outputted or not according to a data bar signal DB outputted from a signal generator 1310. FIG. 8 is a timing chart showing the operation of the pulse generating circuit according to the modified example 4. During the period from t7 to t8 shown in FIG. 8, the data bar signal DB is L level. Thus, the discharge signal Y1 is H level and the secondary battery C4 is discharged. During the period from t15 to t16, the data bar signal DB is H level. Thus, the discharge signal Y1 maintains L level, and the secondary battery C4 is not discharged. During the period from t19 to t20, the data bar signal DB is L level. Thus, the discharge signal Y1 is H level, and the secondary battery C4 is discharged.

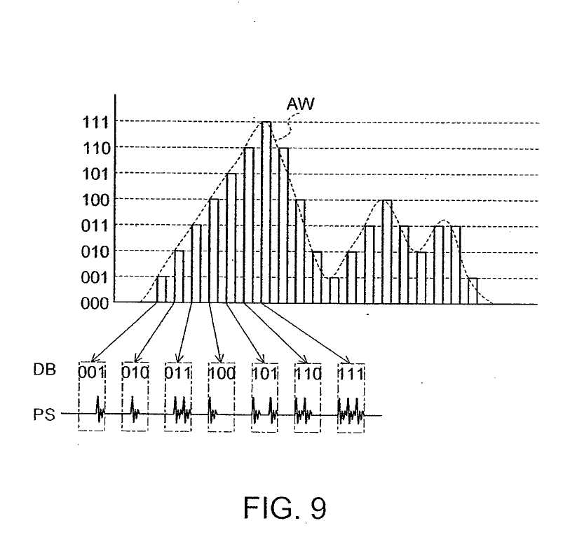

FIG. 9 schematically illustrates an application example of the pulse generating circuit according to the modified example 4. FIG. 9 shows the case for outputting the pulse PS after pulse code modulation (PCM) of analog waveform AW using 3-bit data. By controlling the data bar signal DB, the data bar signal DB becomes H level at the time of outputing the waveform of the upper 1st bit when the 3-bit data is “001”, for example. In this case, the data bar signal DB becomes H level at the time of outputting the waveform of the second bit, and becomes L level at the time of outputting the waveform of the third bit. When the bio-information acquiring unit 1003 is a pulse sensor, pulse data is transmitted by 3-bit data to the antenna 1004.

The entire disclosures of Japanese Patent Application No. 2008-219264, filed Aug. 28, 2008 and Japanese Patent Application No. 2007-301312, filed Nov. 21, 2007 are expressly incorporated by reference herein.

What is claimed is:

1. A pulse generating circuit, comprising:
a boosting circuit which boosts power source voltage supplied from an external primary battery and produces boosted voltage higher than the power source voltage;
a secondary battery to be charged with the boosted voltage;
a pulse circuit which generates a pulse;
a switch element connected between the secondary battery and the pulse circuit; and
a control circuit which enables the boosting circuit and thus switches off the switch element during a charge period for charging the secondary battery with the boosted voltage, disenables the boosting circuit and thus switches on the switch element during a discharge period for discharging the boosted voltage contained in the secondary battery.

2. The pulse generating circuit according to claim 1, wherein the boosting circuit is a charge pump circuit.

3. A transmitter, comprising:
the pulse generating circuit according to claim 1; and
an antenna which radiates the pulse generated by the pulse circuit.

4. An electronic device, comprising the pulse generating circuit according to claim 1.

5. A control method for a pulse generating circuit for controlling a pulse generating circuit which includes a boosting circuit which boosts power source voltage supplied from an external primary battery and produces boosted voltage higher than the power source voltage, a secondary battery to be charged with the boosted voltage, a pulse circuit which generates a pulse, and a switch element connected between the secondary battery and the pulse circuit, the method comprising:
a boosting step for enabling the boosting circuit and switching off the switch element during a charge period, and charging the secondary battery with the boosted voltage; and
a pulse generating step for disenabling the boosted circuit and switching on the switch element during a discharge period, and discharging the boosted voltage contained in the secondary battery to supply the boosted voltage to the pulse circuit and generate the pulse.
